(19) United States
(12) Patent Application Publication
(10) Pub. No.: US 2010/0294440 A1
(43) Pub. Date: Nov. 25, 2010

(54) MULTI-PLANAR SHADE SYSTEM AND METHOD

(75) Inventors: Xi Ming Li, Brooklyn, NY (US); Eugene Miroshnichenko, Oceanside, NY (US)

Correspondence Address: SNELL & WILMER L.L.P. (Main), 400 EAST VAN BUREN, ONE ARIZONA CENTER, PHOENIX, AZ, 85004-2202, US

(73) Assignee: MECHOSHADE SYSTEMS, INC., Long Island City, NY (US)

(21) Appl. No.: 12/471,100

(22) Filed: May 22, 2009

(51) Int. Cl. E06B 9/68; E06B 9/56

(52) U.S. Cl. 160/310; 160/323.1; 160/309; 160/405

(57) ABSTRACT

An automated shade system that shades windows on different planes is disclosed. The automated shade system comprises a roller tube with shade material wound on the roller tube connected to a second roller tube with a second shade material wound on the second roller tube, wherein each roller tube is at an angle to the other. The roller tubes are connected by an off axis connector that transmits torque between the two roller tubes. The system has only one drive mechanism to operate the non coaxial roller tubes, whereas other shade systems would require separate drive mechanisms for each roller tube.

### FIELD OF INVENTION

This invention generally relates to a shade system, and more particularly, to an automatic shade system that provides precision control of shades around multi-planar architecture.

### BACKGROUND OF THE INVENTION

A variety of automated systems currently exist for controlling the retrieval and deployment of materials, blinds, draperies, and other types of window coverings. These systems are applied to numerous window shading applications. Occasionally, windows and automated systems follow a non-planar or curved path around the face of a structure. Current systems typically require multiple drive mechanisms and shades to cover these walls, windows, or surfaces.

The multiple drives typically use multiple motors, and the highest price item in a shade system is frequently the motor. As such, substantial cost savings may be realized by not having to provide multiple motors for a system. Currently, there is no sufficient precision controlled single drive shade system that is capable of deploying and retrieving multiple shades across multiple non-planar structural surfaces.

### SUMMARY OF THE INVENTION

An automatic shade system that provides precision control of shades around non-planar architecture is disclosed. In one embodiment, the shade system comprises a first roller tube having a first roller axis; a first shade material wound on the first roller tube; a second roller tube having a second roller axis; a second shade material wound on the second roller tube; a connector that transmits torque between the first roller tube and the second roller tube; a support bracket configured to support the roller tube; and, a drive mechanism.

An automated shade control system may also comprise multiple shade systems, sensors, and controllers. Each shade system may comprise a single motor to drive multiple window shades attached to individual shade tubes. The system may also include the use of one or more proactive, reactive, and/or other algorithms to guide the behavior of the system. An automated shade control system may also comprise one or more databases, centralized control systems, and computing devices.

### BRIEF DESCRIPTION OF THE DRAWINGS

The accompanying drawings, wherein like numerals depict like elements, illustrate exemplary embodiments of the present invention, and together with the description, serve to explain the principles of the invention.

FIG. 1 illustrates top view of one embodiment of a shade system.

FIG. 2 illustrates a view highlighting one embodiment of a support bracket.

FIG. 3 illustrates a front view of one embodiment of a shade system.

FIG. 4 illustrates a view of one embodiment of an off axis connector.

FIG. 5 illustrates an exploded view of one embodiment of an off axis connector and an engagement with a roller tube.

### DETAILED DESCRIPTION

The detailed description of exemplary embodiments of the invention herein shows the exemplary embodiment by way of illustration, diagrams and various processing steps including the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected, supported or the like may include permanent, removable, temporary, partial, full and/or any other possible attachment or support option. Additionally, any reference to without contact (or similar phrases) may also include reduced contact or minimal contact.

Moreover, for the sake of brevity, certain sub-components of individual components and other aspects of the system may not be described in detail herein. Furthermore, the connecting lines shown in the various figures contained herein are intended to represent exemplary functional relationships or physical couplings between the various elements. It should be noted that many alternative or additional functional relationships, wireless connections or physical couplings may be present in a practical system. Such functional blocks may be realized by any number of components configured to perform specified functions.

In one embodiment, the shade system is configured to deploy and retrieve two or more segments of shade material wrapped around two or more segments of roller tube, each roller tube having a different axis from the other roller tube in the system. Roller tubes with intersecting axis can allow shades to cover intersecting planes or windows on different walls. The system may also be configured to maintain tight tolerances between multiple shade material bottom edges. The system may also be configured to operate with only one drive mechanism.

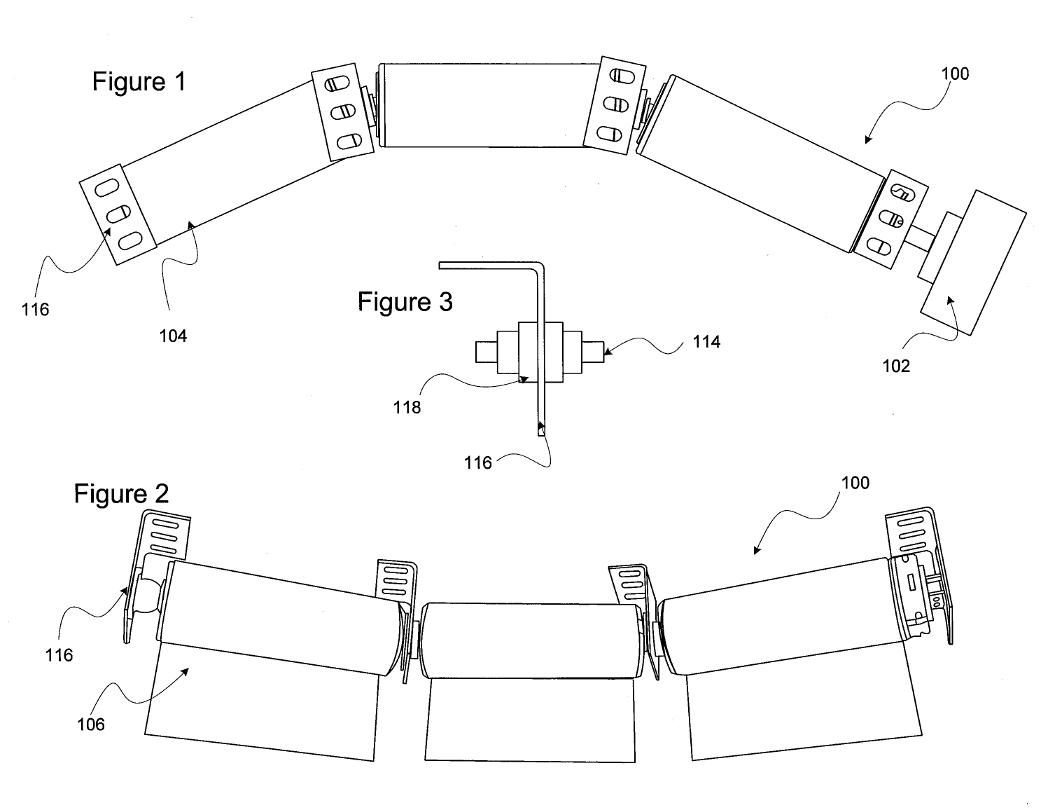

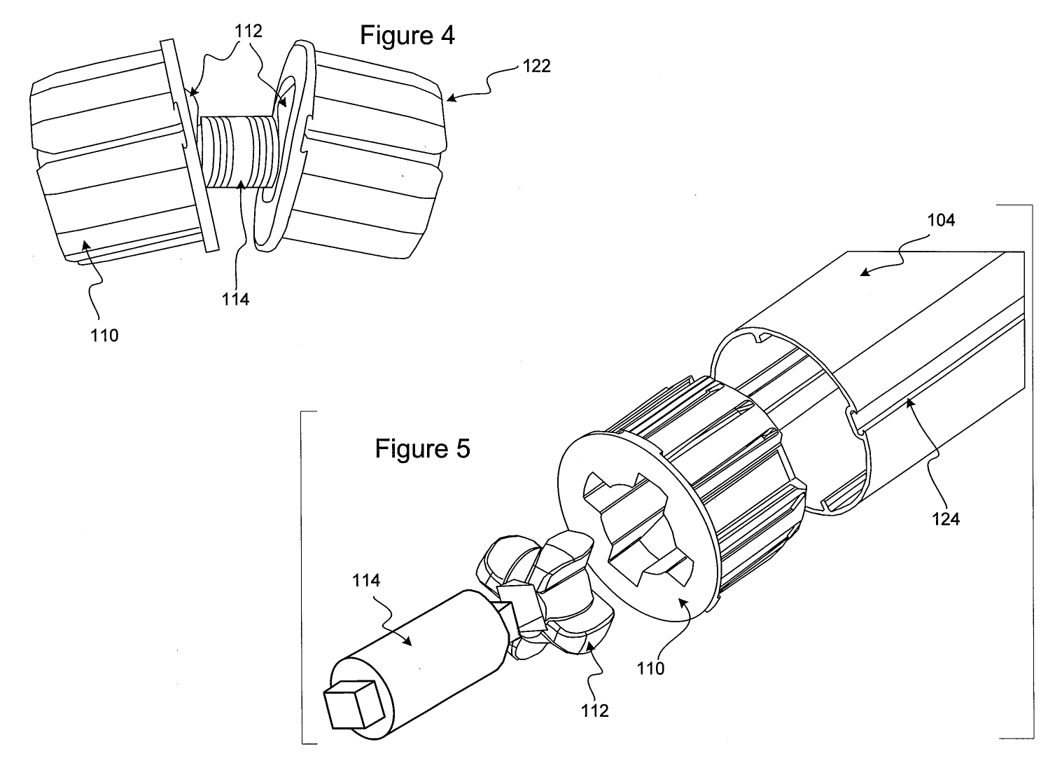

With reference to FIG. 1, and in accordance with an exemplary embodiment, shade system 100 comprises drive mechanism 102; first roller tube 104 having a first roller axis; first shade material 106; at least a second roller tube having a second roller axis; at least a second shade material; off axis connector 122; support brackets 116; and bearing 118.

Continuing with reference to FIG. 1, and in accordance with an exemplary embodiment, roller tube 104 comprises a structure configured to receive and/or support shade material 106 in a winding a manner. With reference to FIG. 2, roller tube 104 may include groove 124, flanges, trenches, or other portions configured to facilitate attachment of shade material 106 to roller tube 104. Roller tube 104 may also be configured in any suitable manner for receiving and engaging off axis connector 122.

In accordance with one embodiment, roller tube 104 may be an extruded hollow circular tube with appropriate features to receive both shade material 106 and end cap 110. Roller tube may also comprise any shape and cross sectional area which permits the tube to engage with a connector and support shade material in a winding manner. Each roller tube in the system can have individual specifications. In a system with multiple roller tubes, each tube may be configured with a different length, width, or cross section. Further, each tube may be configured to support different shade materials, support different shade lengths, or to provide a different aesthetic look from one roller tube to another.

Roller tube 104 may partially or fully comprise aluminum, steel, copper, magnesium, titanium, or other suitable durable metal, and/or various alloys or variations on the same, such as stainless steel, A36 steel, galvanized steel, duralumin, silumin, 6061 aluminum, and the like, or any combination thereof. Roller tube 104 may also be partially or totally comprised of a composite structure, a plastic structure, a carbon fiber structure, or other suitable material configured to receive and support shade material in a winding manner. Roller tube 104 may be manufactured by any suitable manufacturing processes so as to obtain the desired characteristics specific to the embodiment. A non-exclusive list of examples may include casting, molding, forging, extruding, and machining.

In one embodiment, roller tube 104 may be fully or partially supported by off axis connector 122. In another embodiment, roller tube 104 may be fully or partially supported by bearing 118 which in turn is supported by support bracket 116. In another embodiment roller tube 104 may be fully or partially supported by a connection with drive mechanism 102, wherein such a connection may function much like the off axis connector engagement with roller tube 104. In another embodiment, each roller tube incorporated in the shade system may be fully or partially supported by any combination of support from off axis connector, support bracket, drive mechanism or other method known to support rotating elements.

Drive mechanism 102 comprises any suitable device configured to provide rotational force to roller tube 104 and/or any other roller tubes as may be attached in the system. Examples may include a brushless direct current (DC) motor, a brushed DC motor, a coreless DC motor, a linear DC motor, and the like. Drive mechanism 102 may also comprise an alternating current (AC) motor, an induction motor, a cage rotor motor, a slip ring motor, a stepper motor, and the like. In various exemplary embodiments, drive mechanism 102 comprises a tubular motor inserted into roller tube 104. Moreover, any motor or similar device presently known or adopted in the future to drive roller tube 104 within shade system 100 falls within the scope of the present invention. In other exemplary embodiments, drive mechanism 102 may be replaced with another suitable torque generation mechanism capable of moving roller tube 104 such as a pulley, crank, or chain drive system.

In accordance with one embodiment, drive mechanism 102 is mounted to support bracket and/or drive mechanism 102 is mounted to a structure. Drive mechanism may be mounted to a bracket configured to mount drive mechanism to the structure.

Shade material 106 comprises any suitable shade material configured to provide the desired shading effect such as to facilitate control of solar glare, daylighting, brightness, contrasting brightness, luminance ratios, room darkening, blackout, solar heat gain or loss, UV exposure, uniformity of design or any benefit to provide a better interior environment for the occupants of a structure supporting increased productivity, and the like. Shade material 106 is further configured to connect and wind around roller tube 104. Exemplary embodiments of shading material may include such materials as polyester, cotton, nylon, teflon, high density polyethelyene (HDPE), polyvinyl chloride (PVC), thermoplastic olefin (TPO), fiberglass, room darkening and/or blackout fabrics with a laminated or black-out coating, and the like, or any combination of the above may be used with roller tube 104.

In accordance with an exemplary embodiment, shade system 100 may further comprise side channels to minimize edge-of-shade light leaks (such as those occurring due to the distance between the edge of one shade material segment and the end of the next shade material segment). Smooth deployment of long, high shades often utilize a roller tube that may be configured to prevent the changing of the location of the shade material in relation to side channels or windows, and allow the shade material to be inserted into side channels. Shade system 100 can be combined with other shade system mechanisms to accomplish similar specific tasks. In accordance with one exemplary embodiment, shade system 100 can be combined with, as an example, Trough Shade System and Method as disclosed in U.S. patent application Ser. No. 12/266,632 filed on Nov. 7, 2008, which is hereby incorporated by reference. Such a system allows the use of side channels and larger rolls of shade material, while still allowing coverage of multiple non planar surfaces with only one drive mechanism. The benefits of the trough shade system may be combined together with the benefits of shade system 100.

With reference to FIG. 4 and FIG. 5, off axis connector 122 comprises a mechanism configured to transmit torque between first roller tube 104 and second roller tube (among possibly any number of other roller tubes). Off axis connector 122 also connects any additional roller tubes in the system to adjacent roller tubes. Off axis connector 122 connects roller tubes with intersecting axes or with co-linear axes. Off axis connector may have sufficient rigidity and well controlled tolerances so that the angular tolerance stack-up between shade rollers is negligible. This will maintain substantially equal hem lengths between shade materials in the shade system. Off axis connector 122 may also provide off axis torque transmission such that torque can be transmitted between roller tubes with different axes, allowing the shade system to cover surfaces on different planes.

In accordance with one exemplary embodiment, off axis connector 122 comprises shaft 114 with a first hub 112 inserted over a first end of shaft 114, a second hub 112 inserted over a second end of shaft 114, a first end cap 110 inserted over the first hub 112 and a second end cap 110 inserted over the second hub 112. Shaft 114 may comprise a cylindrical center portion capable of serving as a contact surface for bearing 118. Shaft 114 may further comprise keyed ends. The square shape of the keyed end of shaft 114 is configured to engage with hub 112 so that torque is transmitted from one to the other with negligible back lash. Hub 112 comprises a cross-shaped spherical lobe with a keyed receptacle configured to receive the keyed end of shaft 114. As an exemplary embodiment, shaft 114 has square keyed ends and hub 112 has a square receptacle to receive the square keyed end of shaft 114. End cap 110 comprises a receptacle configured to match the cross-shaped spherical lobe of hub 112 so that, when hub 112 is engaged with the end cap 110, torque is transmitted from one to the other with negligible back lash. End cap 110 may further comprise a shape configured to match an end of roller tube 104 so that, when end cap 110 and roller tube 104 are engaged, torque is transmitted from one to the other with negligible back lash.

Off axis connector 122 may be assembled such that edge clearances between end cap 110 and support bracket 116 are maintained at a sufficient distance to prevent or minimize interference. When more extreme angles between roller tubes are desired, the distance in which hub 112 is inserted into end cap 110 may be decreased. The freedom to adjust the distance in which hub 112 is inserted into end cap 110 allows for freedom to make beneficial adjustments, such as, for example, partially or fully controlling the distance between shade material and a side channel, or partially or fully controlling the distance between end caps and support brackets.

Off axis connector 122 provides better wear resistance because it allows the surface area of the hub to carry the torque load and there is also only linear contact with little pressure where friction occurs between hub 112 and the end cap 110. Off axis connector 122 is capable of operating with an angular deviation of about 10 degrees on each side of the system (about 20 degrees total). In an embodiment, the off axis connector comprises any known off axis coupling, drive shaft, or connector. A non-exclusive list of examples may include universal joints, CV joints, and flexible shafts. Off axis connector may be supported by a bearing which is supported by a support bracket. In accordance with an embodiment, off axis connector is supported by its connection with roller tube 104.

Off axis connector 122 may comprise any base material having desirable strength and/or weight characteristics. Off axis connector 122 or the individual members of off axis connector 122 may partially or fully comprise aluminum, steel, copper, magnesium, titanium, or other suitable durable metal, and/or various alloys of or variations on the same, such as stainless steel, A36 steel, galvanized steel, duralumin, silumin, 6061 aluminum, and the like, or any combination thereof. The base material may then be partially or fully coated with a low-friction material to achieve desired properties for off axis connector 122. Some or all elements of off axis connector 122 may further comprise a low-friction coating in order to facilitate easier deployment (unrolling) and retrieval (rolling) of shade material from roller tube 104. In other exemplary embodiments, off axis connector 122 partially or fully comprises a low-friction material, such as high-density polyethelyne (HDPE), ultra-high molecular weight polyethelyne (UHMW-PE), polyoxymethelyne (e.g., Delrin®), polytetrafluoroethylene (e.g., Teflon®), polyethylene terephthalate, and the like, or any combination thereof.

Off axis connector 122 may be manufactured by any suitable manufacturing processes so as to obtain the desired characteristics specific to the embodiment. A non-exclusive list of examples may include casting, molding, forging, extruding, and machining. Manufacturing processes which improve the tolerances for each element benefit the system by decreasing backlash between elements, which improves the consistency of shade lengths between shades. Further it is understood that off axis connector 122 may be manufactured in any number of elements. Shaft 114 with first hub 112 and second hub 112 may be manufactured as one element. In another embodiment, shaft 114 and corresponding hub 112, for each end of shaft 114, may be manufactured as three pieces. In another embodiment, the off axis connector may function without hubs. The keyed ends of shaft 114 may directly engage a matching keyed feature in the end caps which may simplify the manufacture but would substantially increase the wear on the system.

Support bracket 116 comprises a structure configured to partially or fully support the shade system. Support bracket 116 may function as a housing for shade system 100. Further support bracket 116 may be configured for mounting on a building or other surface. Moreover, support bracket 116 may be mounted to any appropriate surface via any suitable technique to secure support bracket 116 in place. Accordingly, support bracket 116 may be coupled to a building by any available method such as mechanical or chemical fastener. Support bracket 116 may comprise multiple members. For example, a first portion of support bracket 116 may be coupled to a building. A second portion of support bracket 116 may be coupled to the first portion via one or more mechanical fasteners. Moreover, portions of support bracket 116 may be coupled together in any appropriate manner configured to secure the portions of support bracket 116 in place.

In an exemplary embodiment, support bracket 116 supports the system in conjunction with bearing 118. Bearing 118 is configured to support and provide low friction for rotating members of the system. In an exemplary embodiment, bearing 118 is situated inside support bracket 116 such that bearing 118 directly supports the bearing surface of off axis connector 122. In another exemplary embodiment, the bearing is situated inside a support bracket such that the bearing directly supports a roller tube.

Support bracket 116 may be manufactured from any material suitable to provide the strength, rigidity, and support to support shade system 100. Support bracket 116 may partially or fully comprise aluminum, steel, copper, magnesium, titanium, or other suitable durable metal, and/or various alloys of or variations on the same, such as stainless steel, A36 steel, galvanized steel, duralumin, silumin, 6061 aluminum, and the like, or any combination thereof. A non-exclusive list of exemplary manufacturing processes may include casting, molding, forging, extruding, machining, and forming, from sheet metal.

In accordance with one embodiment, support bracket 116 is a sheet metal bracket configured to mount directly to a structure which is intended to benefit by the shade system. This embodiment of support bracket 116 is also configured to house bearing 118. In another embodiment, the support bracket comprises a sheet metal housing that contains the entirety of the shade system. In another embodiment, the support bracket comprises a sheet metal housing that contains and supports each roller tube assembly.

Shade system 100 may function with numerous other shade systems, controls, and devices, such as, for example, U.S. Patent Publication No. 2007/0253768 entitled System and Method for an Adjustable Connector filed on Apr. 26, 2007, which is hereby incorporated by reference in its entirety. In an exemplary embodiment, Shade system 100 and an Adjustable Connector may be utilized in tandem to provide adjustments of individual shades relative to one another while also providing the benefits of a Multi-Planar Shade System.

Shade system 100 may also function as an automated shade control system, such as for example, U.S. patent application Ser. No. 12/197,863 entitled Automated Shade Control Method and System filed on Aug. 25, 2008, which is hereby incorporated by reference in its entirety. An automated shade control system may comprise one or more motorized window coverings, sensors, and controllers. The system may also include one or more proactive, reactive, or other algorithms to guide behavior of the system. One or more factors may be incorporated into the algorithms including, but not limited to, for example: lighting and radiation information; ASHRAE clear sky algorithms; log information related to manual overrides; occupant preference information; motion information; real-time sky conditions; solar radiation on a building; a total foot-candle load on a structure; brightness overrides; actual or calculated BTU load; time-of-year information; and/or microclimate analysis. An automated shade control system may also comprise one or more databases, centralized control systems, and computing devices. Moreover, the system may be controlled from a remote location.

Additionally, two or more motorized window coverings may be placed in different configurations in order to direct incoming solar radiation in different ways. For example, a first configuration may protect occupants of a structure, and a second configuration may direct daylight toward the ceiling of a structure to improve illumination.

Roller tube 104 may be operated in any appropriate manner and via any appropriate mechanism to cause shade material to unroll from or roll onto roller tube 104. In one embodiment, drive mechanism 102 causes a portion of shade material 106 to unroll from roller tube 104 or to roll around roller tube 104, based on a signal sent from a control system. Drive mechanism 102 may be configured as any type of stepping motor capable of moving roller tube 104 at select, random, predetermined, increasing, decreasing, algorithmic, or any other increments. For example, drive mechanism 102 may be configured to move roller tube 104 in about 1/16-inch or ⅛-inch increments. Further, drive mechanism 102 may also be configured to have each step and/or increment last a certain amount of time. The time of the increments may be any range of time, for example, less than one second, one or more seconds, and/or multiple minutes. In one embodiment, each ⅛-inch increment of drive mechanism 102 may last five seconds. Drive mechanism 102 may be configured to move roller tube 104 at a rate which results in virtually imperceptible movement of the shade fabric. For example, drive mechanism 102 may be configured to continually iterate finite increments, thus establishing thousands of intermediate stopping positions across a shaded area. The increments may be consistent in span and time or may vary in span and/or time across the day and from day to day in order to optimize the comfort requirements of the space and further minimize abrupt window covering positioning transitions, such as those which may draw unnecessary attention from the occupants of a building.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system, comprising:
a first roller tube having a first roller axis and a first shade material wound thereon;
a second roller tube having a second roller axis and a second shade material wound thereon; and
an off axis connector configured to couple the first roller tube and the second roller tube.

2. The system of claim 1, wherein the off axis connector comprises a shaft, a first hub, a second hub, a first end cap, and a second end cap.

3. The system of claim 1, further comprising a drive mechanism.

4. The system of claim 1, further comprising a support bracket configured to support at least a portion of the system.

5. The system of claim 4, wherein the support bracket comprises a sheet metal bracket housing a mechanical bearing configured to support the off axis connector.

6. The system of claim 4, wherein the support bracket comprises a sheet metal bracket housing a mechanical bearing configured to support an end of a roller tube.

7. The system of claim 4, wherein the support bracket comprises a single housing configured to support the system.

8. The system of claim 1, further comprising a bearing configured to support at least a portion of the system.

9. The system of claim 3, wherein the drive mechanism is an electric motor.

10. The system of claim 1, wherein the off axis connector is configured to be adjustable.

11. A system, comprising:
a first roller tube having a first roller axis and a first shade material wound thereon;
a second roller tube having a second roller axis and a second shade material wound thereon;
an off axis connector comprising a shaft, a first hub, a second hub, a first end cap, and a second end cap, wherein the off axis connector is configured to couple the first and second roller tube;
a drive mechanism comprising an electric motor; and,
a support bracket comprising a sheet metal bracket housing a mechanical bearing configured to support the off axis connector.

12. A method, comprising:
positioning a first roller tube and a second roller tube on intersecting axes;
coupling the first tube and the second tube with an off axis connector;
driving both the first roller tube and the second roller tube with a single drive mechanism; and
rolling a first shade material around the first roller tube and a second shade material around the second roller tube.

13. The method of claim 12, further comprising unrolling the first shade material from around the first roller tube and unrolling the second shade material from around second roller tube.

14. The method of claim 12, further comprising controlling the drive mechanism with a control system.
